(19) United States
(12) Patent Application Publication
(10) Pub. No.: US 2006/0253451 A1
(43) Pub. Date: Nov. 9, 2006

(54) Content exchange between portable device and network

(76) Inventors: Bartel Marinus Van De Sluis, Eindhoven (NL); Elmo Marcus Attila Diederiks, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/548,240

(22) PCT Filed: Mar. 1, 2004
(86) PCT No.: PCT/IB04/50173

§ 371 Date: Sep. 6, 2005

(30) Foreign Application Priority Data
Mar. 10, 2003 (EP) 03100587.9

(51) Int. Cl. G06F 17/30

(52) U.S. Cl. 707/10

(57) ABSTRACT

A service is provided to a user of a mobile CE device with an onboard memory for storing content information. Upon a communication path being established to the device, the device is caused to conditionally overwrite the stored content information with new content information so as to keep the memory substantially filled. The user is enabled to control the conditions for overwriting.

### FIELD OF THE INVENTION

The invention relates to a providing content information for being rendered at a consumer electronics (CE) device. Content information within a CE context as used herein includes audio, video, still pictures, graphics, games, etc. The invention relates in particular, but not exclusively, to portable, mobile and/or wearable CE devices.

### BACKGROUND ART

Despite the fact that storage capacity of electronic, magnetic and optical memories has continued to increase steadily over the past decade(s), the enthusiastic end-user of content information tends to readily find limitations to the storage capacity of any of his/her rendering equipment, especially of portable or mobile CE rendering equipment. Internet services have appeared that let the user lease storage capacity at secure servers on a data network. The user has to be able to connect to them in order to access his/her data, but there are currently very few infrastructures that provide wireless high-speed access to the Internet, and this only if the user is roaming within range of a connection point. An example of such wireless service is the Ricochet network available in the Bay Area of San Francisco.

Accordingly, if the storage capacity of portable devices is considered to be inadequate for storing all content information that has been or will be relevant to the user, a solution is to be found to facilitate access to all relevant content information via the device.

### SUMMARY OF THE INVENTION

The inventors, therefore, provide a content management interface to manage content information to be stored at the user's portable or mobile CE device. The interface operates between the user's portable or mobile CE device on the one hand, and a content repository on the other hand. A method is proposed of providing a service to a user of a, preferably portable or mobile, CE device. Upon a communication path being established to a memory for use in the device, the content information stored in the memory is caused to be conditionally overwritten with new content information so as to keep the memory substantially filled. The establishing of the communication path initiates the conditional overwriting, possibly upon a confirmation of acceptance by the user, and preferably under control of, e.g., a timer in order to keep the overwrite operations spaced well apart over time.

In an embodiment of the invention, the memory is integrated, or otherwise accommodated, in the device. In another embodiment, the memory is housed in a module that is removable from the device. Preferably, the user is allowed to indicate which item(s) of stored content information are to be retained and under what conditions. These items are then prevented from being overwritten. In this manner, the device has always available a substantially full memory with an inventory of content information items, part of which is automatically refreshed upon establishing the path, and part of which is retained as specified by the user. This approach maximizes usage of the memory resources at the mobile device.

For example, upon connecting the device to a resource on a data network, e.g., the Internet, new content is automatically downloaded and stored locally at the device. Selective overwriting is accomplished through having the user indicate what items of the stored content information are to be retained. The remainder of the device's memory, containing items not indicated for being retained and possibly containing unoccupied parts, is (over-) written with new content information. As a result, the device has always got a substantially full memory with content, part of which is kept until purged by the user or until their indications are revoked by the user, and part of which is automatically overwritten upon connection to the resource.

An embodiment of the invention relates to a portable or mobile device for playing out or otherwise rendering content information such as audio, video, still pictures, graphics, games, etc. The device comprises, e.g., a handheld or palmtop device. The device has a memory for storing the content information. The memory is integrated, or otherwise accommodated, in the device or, alternatively, is housed in a module that is removable from the device. The device comprises communication means for establishing a communication path with an external resource for receiving new content information therefrom, and control means for conditionally overwriting the content information in the memory with the new content information so as to keep the memory substantially filled. Communication means and control means may, alternatively, be accommodated in the memory module. The device or module is configured to communicate with the external resource, e.g., a home network, a jukebox, a PC, a set-top box or one or more servers on the Internet, etc. Communication means include, e.g., input/output for a wired or a wireless (e.g., IR or RF) connection to the external resource. The control means supports a content exchange mechanism for creating a balanced, mixed initiative between the device and the resource in order to supply the device with fresh content. The control means includes, e.g., a micro-controller resident at the device or module that operates according to a software program with the option for the user to determine some operations as explained below. The mechanism involves, e.g., enabling the user to assign a transience label to each item of content information stored at the memory through a suitable UI, e.g., at the device itself. The transience label indicates a condition under which the associated content can be deleted or overwritten. For example, one type of transience label indicates that the item, to which it is assigned, is fixed. That is, only the user is allowed to purge this item from the device. Another type of label indicates that both the system and the user have the right to delete the associated item. Yet another type of label relates to items at the device that only the system is allowed to overwrite. As to the latter, consider, e.g., a service on the Internet to which a user can subscribe for receiving content information. Part of the content, as stored at the device, is retained until the service provider decides to overwrite it. This concept can be used for, e.g., personalized advertisements. Within each type, sub-categories can be used to specify further conditions under which an item can be erased. For example, a sub-category of labels specifies that an item can be deleted if a predetermined amount of time has elapsed, or if the new item that is to overwrite it complies with certain predetermined characteristics, e.g., its semantic relevance to the user. Within this context, reference is made to U.S. Ser. No. 09/374,694 (attorney docket PHA 23,737) filed Aug. 16, 1999, for Chanda Dharap for SEMANTIC CACHING, incorporated herein by reference and briefly discussed further below.

In this manner, the invention provides a method for having a balanced inventory of content information comprising content explicitly retained at the device, and content information that gets refreshed upon the communication with the resource being established.

In another embodiment of the invention, the mobile device is accommodated in, e.g., an automobile or another means of transportation (e.g., truck, motorcycle, moped, bicycle, boat). The device is part of the onboard entertainment system, for example. The device or removable module is configured to communicate with, e.g., the home network or the Internet so as to refresh at least part of the content inventory onboard of the vehicle. For example, upon parking the automobile in the garage, the device or module is within range of the home network via an RF link so as to get its content refreshed overnight.

Above example embodiments illustrate how a CE content rendering device is being used as a mobile cache, whose content gets conditionally refreshed upon connection to a content resource. This concept can be used in a service on, e.g., the Internet, as well as in a feature on the user's home network.

Embodiments of the invention include a mobile device for rendering content information for personal use, a memory module, a service to the user of a mobile client, and software for being installed on a mobile device so as to provide the device with this functionality.

### BRIEF DESCRIPTION OF THE DRAWING

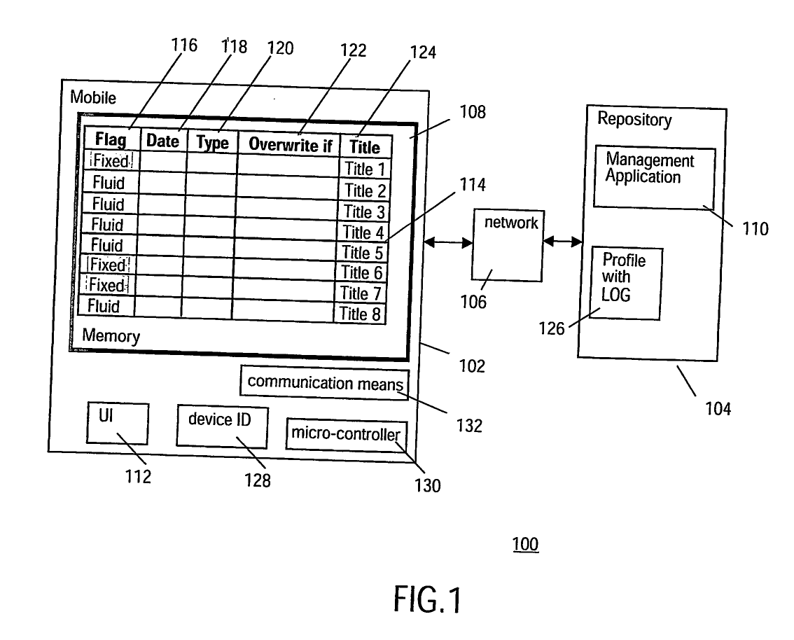

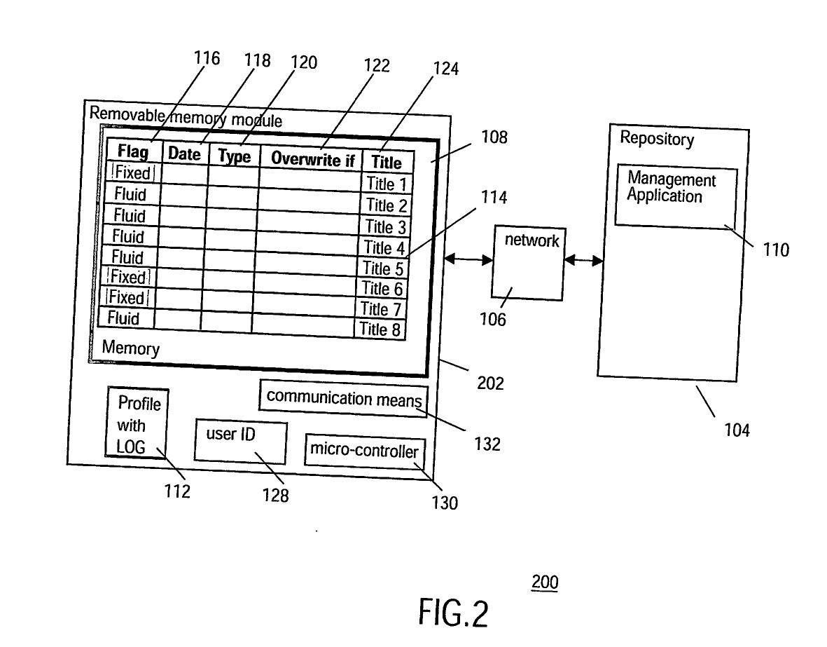

The invention is explained in further detail, by way of example and with reference to the accompanying drawing wherein FIGS. 1 and 2 are block diagrams of a system in the invention. Throughout the drawing, same reference numerals indicate similar or corresponding features.

### DETAILED EMBODIMENTS

As already indicated above, the invention relates to providing a service to a user of a mobile CE device. The device has a memory. Upon a communication path being established to the device, the device is caused to conditionally overwrite content information, stored in the memory, with new content information. This enables to keep the memory substantially filled with content that gets refreshed upon connection to the resource for new content. With respect to the adverb “conditionally” as used herein, a condition is to be determined under which to overwrite one or more specific items of the stored content information. The items get overwritten only if the condition is met. Conditions in this respect typically involve a selection or discrimination based on semantics, the content perceived as meaningful by the end-user, e.g., documentaries, movies, news, music, etc. The user is allowed to specify the condition. Alternatively, or subsidiarily, the service provider is allowed to specify the condition. As yet another example, the combination of the device and the resource for new content information may be able to extract a pattern of usage of the device that enables to automatically optimize the conditional overwriting. Within this context, reference is made to U.S. Pat. No. 6,256,633 (attorney docket PHA 23,422) issued to Chanda Dharap for CONTEXT-BASED AND USER-PROFILE DRIVEN INFORMATION RETRIEVAL, incorporated herein by reference, and briefly discussed below. Conditions may involve, e.g., permission from the user, one or more criteria under control of the service provider, semantic aspects of the items, type or format of the content information item (e.g., audio file, video file, HTML file [web page], text file, image file), time elapsed since download, etc., or a combination thereof. Preferably, the new content information for (partly) overwriting the stored content information is based on a profile of the user determined by user history or by declared interests.

The data path can be established under control of the user. For example, the user initiates establishing the communication path by physically connecting the device to the resource of content information, directly or via a data network. Alternatively, the user moves the device into the range of a wireless link to the resource and confirms via the device that he/she wants to have the stored content refreshed under the pre-determined conditions. As another example, the service provider initiates establishing the communication path to the device, e.g., upon detection of the device's presence. Within this context, see, e.g., U.S. Ser. No. 09/635,548 (attorney docket US 000107) filed Aug. 10, 2000, for Eugene Shteyn and Paul Rankin for MOBILE MICRO PORTAL, incorporated herein by reference and briefly discussed further below.

The terms “mobile” and “portable” as used in this text do also include “wearable”. The term “wearable electronics” refers to devices that are physically integrated in, e.g., professional or leisure clothing, jewelry or other personal ornaments, made possible by means of the ever proceeding miniaturization of electronic circuitry and HDDs. Within this context, wearable electronic devices may form parts of a personal area network (PCAN). For more background on PAN, see, e.g., U.S. Ser. No. 09/900,375 (attorney docket US 018098) filed Jul. 5, 2001 for Eugene Shteyn for DIAL FACE OF WATCH GRAPHICALLY REPRESENTS CALENDAR, incorporated herein by reference and briefly discussed further below.

FIG. 1 is a block diagram of a system 100 according to the invention. System 100 comprises a mobile device 102 and a repository 104 that communicate in this example via a network 106. Instead of a network, the connection between device 102 and repository 104 is established in other examples via, e.g., a cable or docking station, etc. The link between device 102 and repository 104 can be wireless or wired. Device 102 is configured to play-out content information stored at device 102 and to communicate with repository 104. Device 102 is, e.g., a dedicated content rendering apparatus or a general-purpose palmtop or laptop computer, or a mobile phone. Repository 104 is configured to supply to device 102 content information selected from its inventory. Repository 104 is accommodated in, e.g., a PC, a jukebox, a seet-top box or digital video recorder (DVR) or is available in distributed fashion on a home network, or is available on the Internet, or is accommodated in another mobile device. Repository 104 need not be a geographically centralized system, and can be a distributed system. Within this context of a distributed heterogeneous content processing system, reference is made to U.S. Ser. No. 09/568,932 (attorney docket US 000106) incorporated herein by reference and briefly discussed further below.

Device 102 comprises a memory 108 for storing content information for play-out or other rendering. Memory 108 also stores control information to enable to control storage and to enable to facilitate user interaction with device 102. System 100 further comprises software 110 for managing the transfer of content from repository 104 to device 102. In the example shown, application 110 is accommodated in repository 104, but could also, in other embodiments, be resident in device 102 or can be distributed between device 102, network 106 and repository 104.

Device 102 has a user-interface (UI) 112 that enables the user to control device 102 in order to select content stored in memory 108 for rendering, and to locally manage the content in memory 108. In this example, the user can specify one or more conditions, under which the content stored in memory 108 is permitted to be overwritten by new or fresh content from repository 108. For example, the user can specify that he/she wants to have all news-flashes stored in memory 108 overwritten with current ones upon connection to repository 104. The user may have specified in advance that not more than five news-flashes are to be stored selected from categories as specified by the user in advance through, e.g., key words via UI 112. The same user can have indicated that he/she wants to retain music files for at least four days under the condition that at the most two of the stored music files are to be overwritten before the four day period has elapsed, if in the meantime new songs from specific performers have become available at repository 104. As another example, the user may specify that a fixed percentage of the stored content is to be retained every time repository 104 is connected to device 102. The configuring of system 100 in order to transfer content from repository 104 to device 102 according with the conditions can be done in advance, e.g., via device 102 or via another apparatus.

In the example shown, memory 108 comprises control information representative of the refresh conditions, here in a table 114. Table 114 has columns 116, 118, 120, 122 and 124 with headers “flag”, “date”, “type”, “overwrite if” and “title”, respectively. Column 116 indicates for each piece of content information whether the user wants to retain it (“fixed”) or whether it is allowed to be overwritten (“fluid”). Column 118 indicates for each piece the time and/or date of its download into memory 108. Column 120 indicates for each piece its semantic type, e.g., “news”, “audio clip”, “video clip”, “picture”, “web page”, etc. Column 122 indicates for each piece the condition(s) under which the relevant piece can be overwritten by new content from repository 104. Note that conditions may depend on the other pieces of content stored in memory 104. For example, the user's retention policy regarding video clips depends on whether memory 108 has enough storage capacity to store the news items. If not, the user may want to sacrifice a video clip to obtain news-flashes about Wall Street and about the Middle East. Column 124 gives brief descriptions of the relevant pieces of content in memory 108. In addition, the user may specify different conditions per semantic type.

Operation is further as follows. Upon connecting device 102 to repository 104, application 110 retrieves user profile 126, e.g., based on user-ID or device-ID 128. In this example it is assumed that profile 126 comprises information about previous downloads to device 102, about this user's preferences, and about the conditions as relating to the user's retention policy represented by the conditions in columns 116 and 122 of table 114. This profile may be stored in its entirety on device 102, in its entirety at repository 104, may be stored at an application server (not shown) on network 106, or may be distributed between them. Upon connection being established between device 102 and repository 104, it is determined (e.g., by device 102, or by application 110) how much of storage capacity of memory 108 is to be overwritten and with what content. The conditions as specified enable to control this. In the event of an ambiguity, application 110 may decide to select new content as deemed fit in view of profile 126. In order to enable above functionalities, device 102 has an onboard micro-controller 130 and means 132 (e.g., a jack for a cable, an IR or RF port for wireless communication, etc.) in order to connect to repository 104.

FIG. 2 is a block diagram of another embodiment of a system 200 in the invention. In system 200, memory 108 is accommodated in a module 202 that is removable from device 102. In this manner, module 202 can be connected to repository 104 independent of device 102. For example, device 102 is multi-functional in the sense that it has further capabilities in addition to the rendering of content information stored in memory 108. In another example, module 202 can be used with a variety of rendering or play-out devices configured to cooperate with module 202. Module 202 further comprises user profile 126 with the history log, and device ID or user ID 128, and micro-controller 130 to control storage. Module 202 also comprises communication means 132 to enable connecting to repository 104.

It is noted that, although the invention is believed to be highly convenient to mobile, portable or wearable CE devices, the usefulness of stationary CE equipment may benefit as well from the conditional overwriting as specified above.

For completeness, reference is made to the following documents, herein incorporated by reference:

U.S. Ser. No. 09/374,694 (attorney docket PHA 23,737) filed Aug. 16, 1999, for Chanda Dharap for SEMANTIC CACHING, and published under PCT as International Application WO200113265. This patent document relates to a scheme for caching electronic content information that is governed by the semantics of the documents.

U.S. Ser. No. 09/635,548 (attorney docket US 000107) filed Aug. 10, 2000, for Eugene Shteyn and Paul Rankin for MOBILE MICRO PORTAL, and published under PCT as International Application WO200213556. This patent document relates to a geographic region with a network of beacons. Each beacon transmits a short-range facilitation signal for receipt on a user's mobile communication device. The facilitation signal initiates associating the facilitation signal with a service and conditionally alerts the user to the service via the device dependent on a user profile. The user-profile and the association between facilitation signal and service are user-programmable. incorporated by reference:

U.S. Ser. No. 09/568,932 (attorney docket US 000106) filed May 11, 2000, for Eugene Shteyn and Rudy Roth for ELECTRONIC CONTENT GUIDE RENDERS CONTENT RESOURCES TRANSPARENT, and published under PCT as International Application WO200186948. This document relates to a data management system on a home network. The system collects data that is descriptive of content information available at various resources on the network. The data is combined in a single menu to enable the user to select from the content, regardless of the resource.

U.S. Ser. No. 09/802,618 (attorney docket US 018028) filed Mar. 8, 2001 for Eugene Shteyn for ACTIVITY SCHEDULE CONTROLS PERSONALIZED ELECTRONIC CONTENT GUIDE, and published under PCT as W002071266. This document relates to determining electronic content information and the time slots for play-out, based on the activities scheduled in the user's electronic calendar and the user's profile or declared interests. In this manner, the recording and downloading of content is automated based on the user's life style.

U.S. Pat. No. 6,256,633 (attorney docket PHA 23,422) issued Mar. 7, 2001 to Chanda Dharap for CONTEXT-BASED AND USER-PROFILE DRIVEN INFORMATION RETRIEVAL. This document relates to enabling a user to navigate through an electronic data base in a personalized manner. A context is created based on a profile of the user, the profile being at least partly formed in advance. Candidate data is selected from the data base under control of the context and the user is enabled to interact with the candidates. The profile is based on topical information supplied by the user in advance and a history of previous accesses from the user to the database.

U.S. Ser. No. 09/900,375 (attorney docket US 018098) filed Jul. 5, 2001, for Eugene Shteyn for DIAL FACE OF WATCH GRAPHICALLY REPRESENTS CALENDAR. This document, published as U.S. patent application US 20030007420 A1, relates to an electronic device that has a timepiece with a dial face. The dial face comprises a display monitor for providing a graphical representation of a scheduled event. The representation comprises a segment whose length is associated with the duration of the event and whose graphical attributes correspond with a type of the scheduled event as specified by the user in advance. The device is, for example, a watch that communicates with the user's PDA through a Bluetooth link in the user's Personal Area Network.

1. A method of providing a service to a user of a mobile CE device, the method comprising, upon a communication path being established to a memory for use in the device, initiating to conditionally overwrite content information, stored in the memory, with new content information so as to keep the memory substantially filled.

2. The method of claim 1, wherein the initiating comprises:
determining a condition for overwriting a specific item of the stored content information; and
overwriting the specific item only if the condition is met.

3. The method of claim 2, wherein the user is allowed to specify the condition.

4. The method of claim 2, wherein a provider of the service is allowed to specify the condition.

5. The method of claim 2, wherein the condition involves permission of the user.

6. The method of claim 1, comprising selecting the new content information based on a profile of the user.

7. The method of claim 1, wherein the data path is established under control of the user.

8. The method of claim 1, wherein the data path is established under control of a service provider.

9. The method of claim 1, wherein the device is accommodated in a means of transportation.

10. The method of claim 2, wherein the condition depends on a semantic aspect of the content information stored.

11. A mobile CE device for rendering content information, the device comprising:
a memory for storing content information;
communication means for establishing a communication path with an external resource for receiving new content information therefrom;
control means for conditionally overwriting the content information in the memory with the new content information so as to keep the memory substantially filled.

12. The device of claim 11, comprising a UI for enabling a user to specify a condition for the conditional overwriting.

13. The device of claim 11, storing an identification of the user for being communicated with the resource.

14. The device of claim 13, wherein the identification comprises a profile of the user.

15. The device of claim 11, wherein the memory is removable or disconnectable from the device by an end-user.

16. A module for use with a device for rendering content information, the module comprising:
a memory for storing the content information;
communication means for establishing a communication path with an external resource for receiving new content information therefrom;
control means for conditionally overwriting the content information in the memory with the new content information so as to keep the memory substantially filled.

17. A software application for control of a transfer of content information from a repository to a memory of a client, wherein the application is operative to cause content information, stored in the memory, to be conditionally overwritten with new content information from the repository so as to keep the memory substantially filled upon connecting to the repository.

18. The application of claim 17, configured to enable a user of the client to specify a condition for overwriting the stored content.

19. The application of claim 17, for being installed on the mobile client.
